(19) United States
(12) Patent Application Publication
(10) Pub. No.: US 2021/0072371 A1
(43) Pub. Date: Mar. 11, 2021

(54) AUDIO RECOGNITION OF TRAFFIC PARTICIPANTS

(71) Applicant: Continental Automotive Systems, Inc., Auburn Hills, MI (US)

(72) Inventors: Joerg Scheibel, Lake Orion, MI (US); Joseph Zagroba, Auburn Hills, MI (US)

(21) Appl. No.: 16/567,227

(22) Filed: Sep. 11, 2019

(51) Int. Cl. G01S 13/50; H04R 29/00; G05D 1/02; G05D 1/00; G06K 9/00; G01S 15/93

(52) U.S. Cl. CPC G01S 13/505; H04R 29/005; G05D 1/0255; H04R 2499/13; G05D 1/0088; G06K 9/00825; G01S 15/931; G05D 1/0248

(57) ABSTRACT

A disclosed vehicle driving assist system includes a first sensing system configured for monitoring an environment surrounding a vehicle and generating a first signal indicative the environment surrounding the vehicle, an audio recognition system configured for monitoring noise signals surrounding the vehicle and generating a second signal indicative of a traffic participant surrounding the vehicle, and a controller configured to receive the first signal from the first sensing system and the second signal from the audio recognition system, verify the first signal from the first sensing system utilizing the second signal from the audio recognition system and initiate vehicle response based on the verification of the first signal and a determination of the presence of traffic participant surrounding the vehicle based on the second signal from the audio recognition system.

### TECHNICAL FIELD

The present disclosure relates to vehicle advance driver assistance systems and autonomous driving systems.

### BACKGROUND

Vehicles are increasingly implementing systems to assist a driver and/or vehicle in recognizing elements in an environment surrounding the vehicle. Current driver assistant systems may require complex advanced sensing systems. Moreover, each sensor has limited capability.

Vehicle equipment manufacturers are continually seeking ways to increase efficiencies in cost, driver safety while maintaining consumer interest and satisfaction.

### SUMMARY

A method of identifying conditions surrounding a vehicle according to a disclosed embodiment includes, among other possible things, monitoring an environment surrounding a vehicle with a first sensing system to determine an initial sensed environmental condition, receiving noise signals surrounding the vehicle with at least two microphones mounted to a vehicle, comparing the received noise signals with stored noise signals representing a predefined traffic participant, determining a presence of a traffic participant based on the comparison of the received noise signals and the stored noise signals representing a predefined traffic participant, verifying the initial sensed an environmental condition surrounding the vehicle based on the determination of the presence of a traffic participant and initiating a vehicle response according to predefined actions to prepare the vehicle for an action based on the presence of the traffic participant.

In another disclosed embodiment of the foregoing method, the first sensing system comprises at least one camera mounted to the vehicle capturing images of the environment surrounding the vehicle.

In another disclosed embodiment of any of the foregoing methods, the first sensing system comprises a radar sensing system for detecting traffic participants within the environment surrounding the vehicle.

In another disclosed embodiment of any of the foregoing methods, the first sensing system comprises a LIDAR sensing system for detecting traffic participants within the environment surrounding the vehicle.

Another disclosed embodiment of any of the foregoing methods, including detecting a location of the traffic participant based on a Doppler shift in the received noise signals.

Another disclosed embodiment of any of the foregoing methods, including detecting a direction of movement of the traffic participant based on the Doppler shift in the received noise signals.

Another disclosed embodiment of any of the foregoing methods, including detecting the traffic participant based on the noise signals prior to detection by the first sensing system.

In another disclosed embodiment of any of the foregoing methods, vehicle response comprises priming a brake system in preparation for actuation.

In another disclosed embodiment of any of the foregoing methods, wherein the vehicle response comprises initiating a vehicle maneuver in view of the presence of the traffic participant.

A vehicle driving assist system according to another disclosed embodiment includes, among other possible things, a first sensing system configured for monitoring an environment surrounding a vehicle and generating a first signal indicative the environment surrounding the vehicle, an audio recognition system configured for monitoring noise signals surrounding the vehicle and generating a second signal indicative of a traffic participant surrounding the vehicle, and a controller configured to receive the first signal from the first sensing system and the second signal from the audio recognition system, verify the first signal from the first sensing system utilizing the second signal from the audio recognition system and initiate vehicle response based on the verification of the first signal and a determination of the presence of traffic participant surrounding the vehicle based on the second signal from the audio recognition system.

In another disclosed embodiment of the foregoing system, the audio recognition system includes at least two microphones mounted at different locations on the vehicle.

In another disclosed embodiment of any of the foregoing systems, the controller is further configured to determine the presence of a traffic participant based on a comparison of a received noise signal and a stored noise signal representing a predefined traffic participant.

In another disclosed embodiment of any of the foregoing systems, the first sensing system comprises at least one camera mounted to the vehicle capturing images of the environment surrounding the vehicle.

In another disclosed embodiment of any of the foregoing systems, the first sensing system comprises a radar sensing system for detecting traffic participants within the environment surrounding the vehicle.

In another disclosed embodiment of any of the foregoing systems, the first sensing system comprises a LIDAR sensing system for detecting traffic participants within the environment surrounding the vehicle.

In another disclosed embodiment of any of the foregoing systems, the audio recognition system is configured to detect a location of the traffic participant based on a Doppler shift in the received noise signals.

In another disclosed embodiment of any of the foregoing systems, the audio recognition system is further configured to detect a direction of movement of the traffic participant based on the Doppler shift in the received noise signals.

In another disclosed embodiment of any of the foregoing systems, the vehicle response comprises priming a brake system in preparation for actuation.

In another disclosed embodiment of any of the foregoing systems, the vehicle response comprises initiating a vehicle maneuver in view of the presence of the traffic participant.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of an example vehicle including an example audio recognition system.

FIG. 2 is a schematic view of a traffic environment including traffic participants surrounding the example vehicle including the example audio recognition system.

FIG. 3 is a flow chart illustrating a method of utilizing monitored noise to augment vehicle operation.

### DETAILED DESCRIPTION

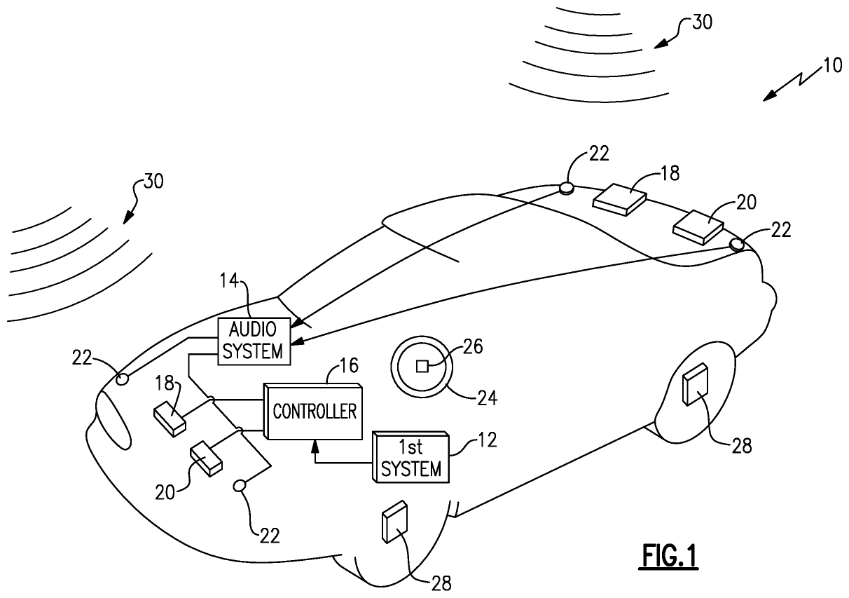

Referring to FIG. 1, a vehicle 10 is schematically shown that includes an audio recognition system 14 that utilizes microphones 22 to monitor noise signals 30. Noise signals 30 around the vehicle 10 and are detected and utilized by the audio recognition system 14 to augment vehicle operation.

The example vehicle 10 includes a first sensing system 12 that communicates with the vehicle controller 16 to provide information about the surrounding environment. The information gathered by the first sensing system 12 is utilized to determine what if any responsive action is needed to address objects and other traffic participants.

The example vehicle controller 16 may be a dedicated controller or a portion of the overall vehicle controller that controls all aspects of vehicle operation. Moreover, the disclosed example controller 16 may be a device and system for performing necessary computing or calculation operations. The system may be specially constructed for this purpose, or it may comprise at least a general-purpose controller selectively activated or reconfigured by a stored program. The method may also be implemented as software providing instructions to a vehicle controller operating the disclosed system.

The vehicle further includes a braking system 28 and a steering assist system 26 that can generate input through a steering mechanism schematically indicated at 24.

The example first sensing system 12 is a sensing system that monitors the environment around the vehicle 10 to provide an input to various vehicle systems such as the braking system 28 and the steering system 24 to prepare such systems for actions depending on what is sensed in the surrounding environment. The first sensing system 12 may include cameras 18. In the disclosed example embodiment, a first camera 18 is disposed in front and rear parts of the vehicle 10 for capturing images that are interpreted to determine aspects of the environment surrounding the vehicle.

The example first sensing system 12 may also be a radar system utilizing radar sensors 20 disposed at the front and rear of the vehicle. In one disclosed embodiment, the sensors 20 are radar sensors and utilize radar signals to determine the location and proximity of objects surrounding the vehicle. The sensors 20 may also be LIDAR sensors that use laser energy to detect and determine the environment including objects and traffic participants that are surrounding the vehicle 10. Moreover, other sensing systems as are known could also be utilized and are within the scope and contemplation of this disclosure.

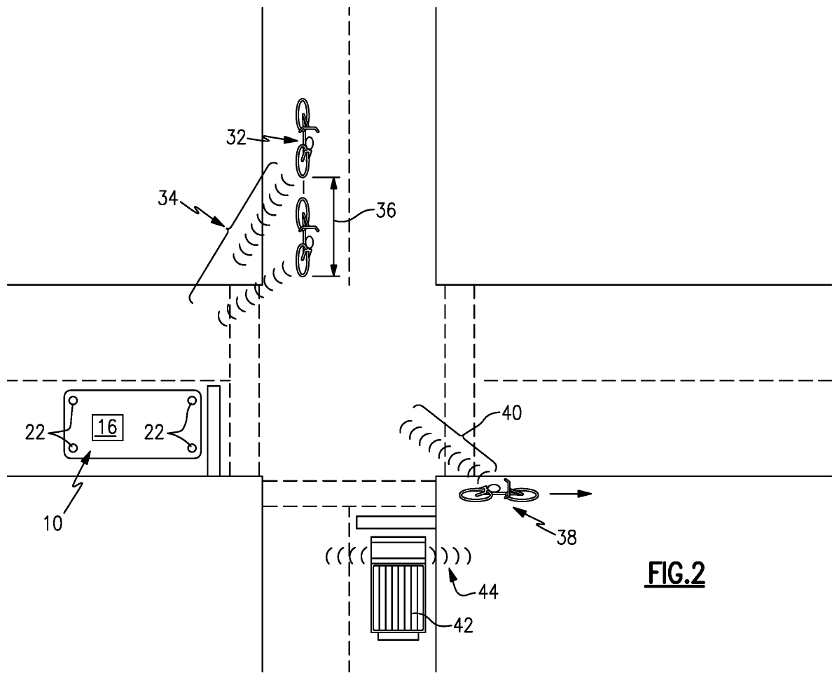

Referring to FIG. 2, with continued reference to FIG. 1, a traffic environment is schematically shown at an intersection with various traffic participants. The vehicle 10 is disposed in one location in the traffic environment and other traffic participants are also disposed within that same area around the vehicle 10. The other traffic participants are all emitting a noise that is monitored and detected by microphones 22.

In the disclosed example embodiment, four microphones 22 are disposed at corners of the vehicle 10 to sense a direction of noise generated by other traffic participants. The spaced apart relationship between the microphones 22 enables the audio recognition system 14 to sense a direction of the noise and thereby the location of the traffic participant. The audio recognition system 14 may also provide information regarding a direction and speed of movement of a traffic participant utilizing differences noise characteristics received at each individual microphone location along with known Doppler affect analysis techniques.

In this disclosed example, the traffic participants include a motorcycle 32 that is moving towards the vehicle and is moving a distance 36 within a period of time. The motorcycle 32 generates a noise signal 34 that is monitored and detected by the audio recognition system 14 of the vehicle 10. The distance 36 can be determined utilizing Doppler analysis techniques.

The noise signals 34 from the motorcycle 36 may be detectable prior to a time when the other vehicle sensing systems may detect the motorcycle 36. The camera 18 and radar sensors 20 may be blocked by objects, such as buildings or landscape features that do not allow a line of sight or direct view of the motorcycle 32. Detection of the noise signal does not require line of sight and therefore enables recognition of the presence of other traffic participants not provided by the first sensing system 12.

Another traffic participant 38 is a bicyclist indicated at 38 that is moving in a direction away from the vehicle 10. The bicyclist may emit a noise 40 that can be compared to a predetermined set of noises that correspond with known vehicle types and configurations. By detecting the bicyclist 38 at a distance utilizing the noise generated from the bicyclist, a determination can be made by the controller 16 as to whether the bicyclist 38 is within a trajectory that would place it within the vehicle's path. It should be appreciated that the bicyclist 38 and motorcyclist 32 can be particularly vulnerable traffic participants due to a driver's limited ability to detect them in high traffic areas and due to buildings and other landscape features. Accordingly, the generation of noise by each of the motorcyclist 32 and bicyclist 38 is utilized by the vehicle 10 to provide advance warning when other systems such as the first system 12 not able to detect the presence of such a traffic participant.

The example system may also be utilized to detect emergency vehicles well before they come into line of sight enabling the driver to take preparatory actions to stop the vehicle well before the emergency vehicle comes into sight or within a path of the vehicle. As appreciated in some instances, an emergency vehicle 42 may be a long distance away and not visible by the camera 20 or the radar 22. However, audio signals 44 generated by the emergency vehicle 42 are well perceived at distances beyond a line of sight and are utilized to determine the direction and speed of the emergency vehicle 42 well before it comes into a range detectable by the camera 20 or radar 22.

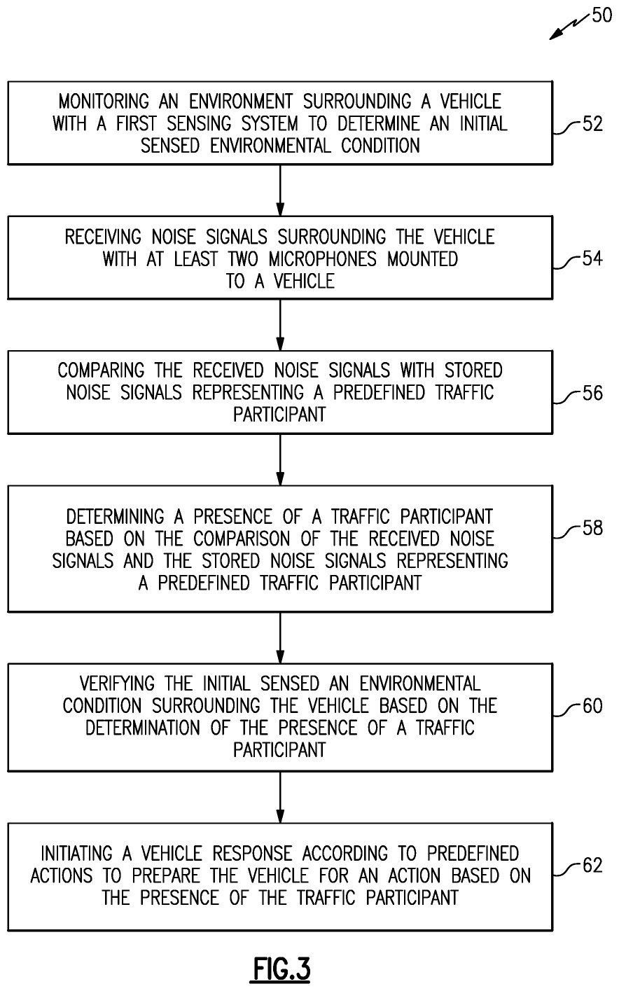

Referring to FIG. 3, with continued reference to FIGS. 1 and 2, an example method of operating the auto recognition system is schematically indicated at 50. The disclosed method includes an initial step 52 of monitoring the environment surrounding a vehicle with a first sensing system 12. The first sensing system 12 may include the cameras 18 and/or the radar sensors 20. This initial monitoring provides an initial sensing of the condition of the environment surrounding the motor vehicle and within a predicted trajectory of the vehicle 10.

The audio recognition system 14 concurrently receives sounds surrounding the vehicle as schematically indicated at 54. The audio recognition system 14 generates information that is used to augment and verify information obtained from other monitoring systems of the vehicle 10. The microphones 22 disposed at each corner of the vehicle enable detection of sound coming from any direction relative to the vehicle 10. Accordingly, sound generated by traffic participants, behind, in front and to the sides of the vehicle 10 are detected and categorized even when not within a line of sight.

The example method continues by comparing the received noise signals with examples of noise signals stored within the controller as is schematically indicated at 56. The example controllers 16 may include a memory device, or be in communication with a memory device or network that contains example noise signals that correspond with known traffic participants. The known traffic participants can include sounds that are indicative of the presence of a motorcycle, a bicyclist, pedestrians, or other motor vehicles. Furthermore, the predefined noise signals can also be representative of other vehicles, specific types of vehicles, as well as the sounds that are representative of other traffic participants or objects that may are considered in the operation of the vehicle 10. For example, the sounds of a bicycling pedestrian may generate a unique sound as compared to sounds generated by a motorcycle or walking pedestrian. Moreover, fixed pedestrian control devices that include audible instructions are detected and used to make decisions regarding vehicle operation.

The method continues as indicated at 58 and includes determining the presence of a traffic participant based on the comparison of the received noise signals to those of the predefined stored noise signals. The information obtained from the audio recognition system 14 is utilized to verify the sensed environment using information obtained from the cameras 18 and the radar sensors 20. The audio recognition system 14 augments operation of the camera 18 and radar sensors 20 by providing additional data utilized to verify the sensed environment. This further augmentation of the sensing abilities of the vehicle 10 increases confidences in environmental monitoring and sensing that further enable automated actions by a vehicle 10.

The method continues as indicated at 60 by initiating a vehicle response according to a predefined actions that prepare the vehicle for actions based on the perceived environment. The perceived environment may include the detection of a possible interception with another traffic participant. In such instances, the controller 16 can take preparatory actions to prepare the vehicle 10 for a short distance stop or for a potential contact with other traffic participants.

The system may also provide an alert or warning to the driver of the presence of a traffic participant. The warning can be in the form of an audible alert, a visual cue or other alert methods. If provided as part of autonomous vehicle, the alert may simply provide information visible to an occupant while taking appropriate action according to predetermined criteria.

The vehicle preparatory responses can include priming of the brake system 28 to stop the vehicle quicker. The response may also include actuation of the steering system 24 to direct the vehicle away from a projected path that intersects with another participant. It should be appreciated that any number of vehicle preparatory responses could be utilized in response to the data confirming the presence and location and predicted path of another traffic participant that is further confirmed by use of the example audio recognition system.

A vehicle operated by a driver is schematically shown and described by way of this example disclosure. However, it is within the contemplation and scope of this disclosure that a partially or fully autonomous vehicle may include the example audio recognition system to augment vehicle information gathering and operation.

Accordingly, the example audio recognition system provides a further data stream that can be utilized to verify environment around the vehicle and improve vehicle operation and functions.

Although an example embodiment has been disclosed, a worker of ordinary skill in this art would recognize that certain modifications would come within the scope of this disclosure. For that reason, the following claims should be studied to determine the scope and content of this disclosure.

What is claimed is:

1. A method of identifying conditions surrounding a vehicle comprising:
monitoring an environment surrounding a vehicle with a first sensing system to determine an initial sensed environmental condition;
receiving noise signals surrounding the vehicle with at least two microphones mounted to a vehicle;
comparing the received noise signals with stored noise signals representing a predefined traffic participant;
determining a presence of a traffic participant based on the comparison of the received noise signals and the stored noise signals representing a predefined traffic participant;
verifying the initial sensed an environmental condition surrounding the vehicle based on the determination of the presence of a traffic participant; and
initiating a vehicle response according to predefined actions to prepare the vehicle for an action based on the presence of the traffic participant.

2. The method as recited in claim 1, wherein the first sensing system comprises at least one camera mounted to the vehicle capturing images of the environment surrounding the vehicle.

3. The method as recited in claim 1, wherein the first sensing system comprises a radar sensing system for detecting traffic participants within the environment surrounding the vehicle.

4. The method as recited in claim 1, wherein the first sensing system comprises a lidar sensing system for detecting traffic participants within the environment surrounding the vehicle.

5. The method as recited in claim 1, including detecting a location of the traffic participant based on a Doppler shift in the received noise signals.

6. The method as recited in claim 5, including detecting a direction of movement of the traffic participant based on the Doppler shift in the received noise signals.

7. The method as recited in claim 1, including detecting the traffic participant based on the noise signals prior to detection by the first sensing system.

8. The method as recited in claim 1, wherein the vehicle response comprises priming a brake system in preparation for actuation.

9. The method as recited in claim 1, wherein the vehicle response comprises initiating a vehicle maneuver in view of the presence of the traffic participant.

10. A vehicle driving assist system comprising:
a first sensing system configured for monitoring an environment surrounding a vehicle and generating a first signal indicative the environment surrounding the vehicle;
an audio recognition system configured for monitoring noise signals surrounding the vehicle and generating a second signal indicative of a traffic participant surrounding the vehicle; and
a controller configured to receive the first signal from the first sensing system and the second signal from the audio recognition system, verify the first signal from the first sensing system utilizing the second signal from the audio recognition system and initiate vehicle response based on the verification of the first signal and a determination of the presence of traffic participant surrounding the vehicle based on the second signal from the audio recognition system.

11. The vehicle driving assist system as recited in claim 10, wherein the audio recognition system includes at least two microphones mounted at different locations on the vehicle.

12. The vehicle driving assist system as recited in claim 10, wherein the controller is further configured to determine the presence of a traffic participant based on a comparison of a received noise signal and a stored noise signal representing a predefined traffic participant.

13. The vehicle driving assist system as recited in claim 10, wherein the first sensing system comprises at least one camera mounted to the vehicle capturing images of the environment surrounding the vehicle.

14. The vehicle driving assist system as recited in claim 10, wherein the first sensing system comprises a radar sensing system for detecting traffic participants within the environment surrounding the vehicle.

15. The vehicle driving assist system as recited in claim 10, wherein the first sensing system comprises a lidar sensing system for detecting traffic participants within the environment surrounding the vehicle.

16. The vehicle driving assist system as recited in claim 10, wherein the audio recognition system is configured to detect a location of the traffic participant based on a Doppler shift in the received noise signals.

17. The vehicle driving assist system as recited in claim 16, wherein the audio recognition system is further configured to detect a direction of movement of the traffic participant based on the Doppler shift in the received noise signals.

18. The vehicle driving assist system as recited in claim 10, wherein the vehicle response comprises priming a brake system in preparation for actuation.

19. The vehicle driving assist system as recited in claim 10, wherein the vehicle response comprises initiating a vehicle maneuver in view of the presence of the traffic participant.
